(19) United States
(12) Patent Application Publication
(10) Pub. No.: US 2015/0166147 A1
(43) Pub. Date: Jun. 18, 2015

(54) INTEGRATED HIGHLY RELIABLE PERSON OVERBOARD SELF-RESCUE SYSTEM

(71) Applicant: Thomas W. Clardy, Park City, UT (US)

(72) Inventor: Thomas W. Clardy, Park City, UT (US)

(21) Appl. No.: 14/626,269

(22) Filed: Feb. 19, 2015

Related U.S. Application Data
(62) Division of application No. 13/587,595, filed on Aug. 16, 2012, now abandoned.
(60) Provisional application No. 61/524,595, filed on Aug. 17, 2011.

(51) Int. Cl. B63B 27/14; E06C 1/38

(52) U.S. Cl. CPC B63B 27/146; E06C 1/38

(57) ABSTRACT

A safety equipment deployment system includes a sensor for receiving input, circuitry for determining whether the input satisfies a time pattern requirement and, responsive to determining satisfaction of the time pattern requirement, triggering release of safety equipment. The safety equipment can include a foldable ladder fixed to a stanchion. The safety equipment can include a device attached to a cord that extends from a bobbin below deck, through a hollow stanchion, and out a top end of the stanchion. A safety deployment system of a marine ship includes a switch operable exteriorly of the ship hull and below deck, for triggering release of safety equipment to be extended exteriorly of the hull to at least as low as the waterline

### CROSS-REFERENCE TO RELATED APPLICATIONS

This application is a divisional, and claims the benefit under 35 U.S.C. §120, of U.S. patent application Ser. No. 13/587,595, filed Aug. 16, 2012, which claims the benefit, under 35 U.S.C. §119(e), of U.S. Provisional Patent Application Ser. No. 61/524,595, filed Aug. 17, 2011, the entire contents of each of which are hereby incorporated by reference.

### FIELD OF THE INVENTION

The present invention relates to a self-rescue system and method, particularly for one who is overboard of a vehicle, and further relates to on-board rescue devices. More particularly, the present invention relates to an arrangement for triggering a marine or aerospace vehicle safety device such as, for example, an ingress ladder or other life saving equipment.

### BACKGROUND

Many vehicles, such as marine vehicles, are structured such that boarding the vehicle by a person who has gone overboard, whether deliberately or by accident, is difficult, if not impossible at times. For example, if a person on a large ship, while in the ocean, jumps out for a swim, forgetting to arrange for safe ingress back onto the ship, or otherwise accidentally falls overboard, it can be difficult for another on board to hoist the overboard person back onboard, and, certainly, where the overboard person is traveling alone, or with no other to save the overboard person, for example, where others on board are asleep, or where there is background noise that prevents others on board from hearing cries for help from a person in the water, returning onboard can be impossible. Conventional mechanical delivery of devices to aid in rescue and ingress to a person who has fallen overboard are prone to failure and unintended release.

U.S. Pat. No. 5,074,236 describes a rope ladder stored in a container that must be conspicuously affixed to a railing or similar structure of a boat and released by tugging on a rope or lanyard that hangs overboard, which device is prone to marine fouling of the container and ladder contents of the container due to the entry point of the lanyard, accidental activation due to forces of nature or unintentional pulling of the lanyard, and inability to trigger due to fouling of the exposed and infrequently used latch mechanism.

### SUMMARY OF THE INVENTION

Example embodiments of the present invention solve the problem of being trapped, e.g., in water, overboard a vessel, e.g., a marine vessel such as a ship, by providing a way to board the vessel. Example embodiments provide an arrangement usable by a person for boarding a vessel without the need for intervention by a person onboard, and without preparation or routine maintenance, even, for example, when the vessel is not in its docked position, e.g., while in middle of the ocean. It requires no strong force or special skills to deploy and make available, but is also provided in a manner that avoids accidental triggering thereof. In an example embodiment, a rescue arrangement is provided that mimics assistance by one on board and who, once alerted by a human-produced call, and not natural in origin, would deploy a rescue ladder, life vest, and/or other life saving equipment for use by the overboard person, and/or would use an onboard rescue radio to transmit a distress call. In an example embodiment, an arrangement recognizes rhythmic tapping on a vessel's hull, distinguishes between naturally occurring tapping and human tapping, an selectively automatically deploys safety equipment conditional upon the tapping being recognized as being of human origin.

In an example embodiment, a sensing arrangement is provided in a nautical vessel, which includes a sensor(s) in the freeboard thereof or below. In an example embodiment, the sensor(s) is provided in a manner by which structural integrity of the vessel can be maintained, for example, in a manner that does not require drilling of holes in the hull of the vessel, and such that the sensor(s) senses a triggering input for triggering safety equipment and/or ingress equipment, and/or for broadcasting a distress call, without the use of an external switch on the vessel's hull, which holes and/or externally mounted triggering mechanism would be prone to leaks and damage due to harsh environmental conditions such as marine fouling.

In an example embodiment of the present invention, the sensor arrangement is configured to sense an input easily input by a person in a frantic state, such a by detecting a tapping or banging by such a person on a ship's hull. Further, in order for such a sensor arrangement to be provided without being prone to marine fouling, the sensor arrangement, in an example embodiment of the present invention, is provided as a proximity sensor arranged within the ship at the ship's hull, which can sense input provided external to the ship's hull. Any suitably appropriate proximity sensor can be used. For example, a capacitance-based proximity sensor, such as described in U.S. Pat. No. 4,001,613, which is incorporated herein in its entirety, can be used. Alternatively (or additionally) an induction-based proximity sensor can be used.

However, naturally occurring and/or other non-human forces, such as the lapping of water or the tapping of objects, whether inanimate or animate, such as fish, might be sensed. For example, a system and method for triggering of safety equipment deployment in response to detection of a single input event can be triggered by lapping of waves or similar forces, falsely indicating an intent to trigger. Accordingly, in an example embodiment of the present invention, circuitry distinguishes between signals generated by non-human generated forces, such as waves, and signals generated by a human. In an example embodiment, the sensory system is configured to detect, by use of the proximity sensor, a predetermined code. A code can be chosen by the ship's owner, to avoid ingress by intruders. Alternatively, for the safety of others who might need saving by ingress onto the ship, e.g., unbeknownst to those aboard, and/or to avoid the possibility of a person overboard forgetting the predetermined code while in duress, a well known code may be used. Additionally, to avoid the requirement of remembering the location of the key inputs and/or of precisely operating separate keys spaced apart from each other, which operation might require a level of dexterity that the person under duress might not have for entering a code while floating in water, in an example embodiment, the arrangement is provided to detect a triggering event by time-patterned input, rather than spatially patterned input. For example, the system can be configured to recognize the universally known SOS signal by time patterned tapping on the ship's hull, e.g., anywhere on the ship's hull, or on one or more designated regions thereof. For example, in an example embodiment, the proximity sensor and associated recognition circuitry an/or algorithm constantly determines whether the predetermined time-patterned code has been tapped on the side of the hull, e.g., at one or more designated regions. In an example embodiment, the system includes multiple sensors for receiving the input, but the multiple sensors are provided redundantly to allow for receipt of the input at various locations, rather than for use to obtain signals according to a spatial pattern.

By requiring a time-patterned input, the system can distinguish between human and non-human input, since it is highly unlikely, if not impossible, for a predetermined time-sequence of input to be accidentally input; yet, by the use of time-sequential input, the preciseness of body control under high duress is not required. Thus, such a system is sufficiently complex so as to not be able to be mimicked accidentally, but simple enough so as to be easily purposefully executed by a human under duress. Moreover, by the use of time-sequential activation using proximity sensors, an external keypad is not required, and also the external markings of keys is also not required. By use of a signal analyzing algorithm, a single signaling input source is used in example embodiments of the present invention, multiple sources not being required to be actuated for the triggering.

An example embodiment of the present invention provides a method of using a proximity sensor coupled with circuitry to execute a timing, counting, and division algorithm to detect a human and intentionally-input signaling event, in response to which detection release or deployment of life saving equipment is triggered.

In an example embodiment of the present invention, responsive to detection of a triggering event, e.g., by sensing a plurality of sub-triggering events in a predetermined time-sequence, the system triggers release and/or deployment of a pre-installed life saving and/or ingress equipment. Non-limiting examples of such equipment include a life vest or other floatation device, a ladder, e.g., a rope ladder or other extendable ladder, and/or an arrangement for generating and outputting, e.g., broadcasting, a radio-based distress call, such as calls of one or more of COSPAS-SARSAT Search And Rescue Satellite Aided Tracking, Global Maritime Distress Safety System GMDSS, Emergency Position-Indicating Radio Beacon (EPIRB), and Digital Selective Calling (DSC).

(In an alternative example embodiment, the system works in reverse, to prevent the generation and output of a distress call in response to the detection of the triggering event. For example, the system is configured to automatically generate and output a distress call after lapse of a predetermined amount of time after a person on board provided input indicating that the person is going overboard without the person subsequently providing input indicating the person's return on board, and the system is configured to allow for the person overboard to input the indication of the return by input detected as the trigger event.)

In an example embodiment of the present invention, the sensor system is configured to run in a test mode, in which the functionality of the sensor system to detect trigger input is tested, but in response to which detection the safety equipment is not deployed.

In an example embodiment of the present invention, the system is configured to run on multiple, e.g., alternative, sources of power, including the vessel's primary power source, the vessel's backup source, a kinetic or photoelectric source, and/or finally a battery backup source, so as to always be available.

Example embodiments of the present invention provide for installation of safety equipment on a vessel, such that the equipment has a small footprint. Still further such equipment, according to an example embodiment, is deployed by a triggering mechanism in response to a signal produced by input via the vessel's hull, as described above, and in further detail below.

In an example embodiment of the present invention, life saving and/or ingress equipment is stored in a container that is permanently affixed to the vessel, so as to not be subject to the weakness of a mariner having to anticipate a life saving event and prepositioning such equipment. For example, the mariner need not remember to hang a rope ladder or other equipment from the deck of the vessel, and over and against the exterior of the hull prior to exiting the vessel, e.g., for a swim. In an example embodiment, the container is affixed in an arrangement that provides for its deployment by a person outside the vessel, allowing for self-rescue, without aid of a person on-board the vessel.

An example embodiment of the present invention is directed to one or more processors, which may be implemented using any conventional processing circuit and device or combination thereof, e.g., a Dynamically Programmable Gate Array (DPGA), a Field-Programmable Gate Array (FPGA), a Digital Signal Processor (DSP), an Application-Specific Integrated Circuit (ASIC), a Complex Programmable Logic Device (CPLD), a microcontroler, a microprocessor, a Programmable System-on-Chip (PSoC), a Central Processing Unit (CPU) of a Personal Computer (PC) or other workstation processor, to execute code provided, e.g., on a hardware computer-readable medium including any conventional memory device, to perform any of the methods described herein, alone or in combination, e.g., for detecting whether a triggering event has occurred. The one or more processors may be embodied in a server or user terminal or combination thereof. The user terminal may be embodied, for example, a desktop, laptop, hand-held device, Personal Digital Assistant (PDA), television set-top Internet appliance, mobile telephone, smart phone, etc., or as a combination of one or more thereof. The memory device may include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape. In an example embodiment, the processor is affixed to a vessel in a permanent-like manner and further coupled to an electric, mechanical, and/or pyro-driven deployment device for deploying safety equipment responsive to detection of a triggering event, by determining, according to the algorithm, satisfaction of a triggering condition.

An example embodiment of the present invention is directed to one or more hardware computer-readable media, e.g., as described above, having stored thereon instructions executable by a processor to perform the methods described herein.

An example embodiment of the present invention is directed to a method, e.g., of a hardware component or machine, of transmitting instructions executable by a processor to perform the methods described herein.

### BRIEF DESCRIPTION OF THE DRAWINGS

FIG. 1 is a block diagram that illustrates components of a system that facilitates self-rescue by a person who is outside a vessel by inputting signals for triggering deployment of safety equipment, according to an example embodiment of the present invention.

FIG. 2 is a flowchart that illustrates a method for detecting that triggering event has occurred, according to an example embodiment of the present invention.

FIG. 3 is a schematic drawing of a foldable ladder, according to an example embodiment of the present invention.

FIG. 4 shows an example part of the ladder, at a point of hinged coupling of two segments thereof, according to an example embodiment of the present invention.

FIG. 5 shows a hinge plate, according to an example embodiment of the present invention.

FIG. 6 shows an end section of a stanchion designed for coupling with a hinge of a foldable ladder, according to an example embodiment of the present invention.

FIG. 7 shows a ladder arrangement in a folded position, according to an example embodiment of the present invention.

FIG. 8 shows an example winch system according to an example embodiment of the present invention.

### DETAILED DESCRIPTION

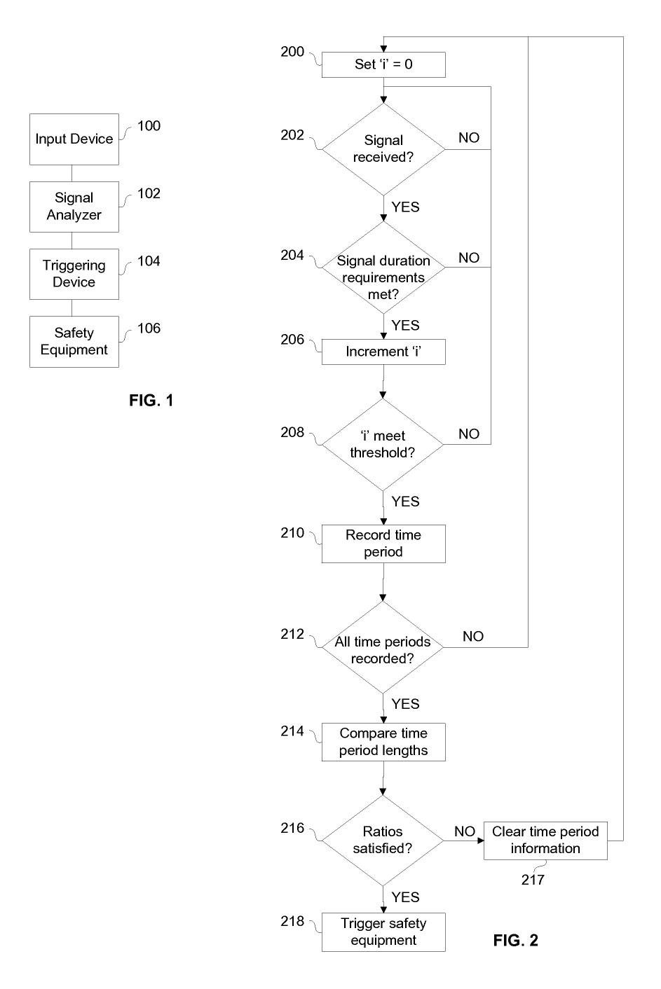

FIG. 1 is a block diagram illustrating components of a system according to an example embodiment of the present invention. In an example embodiment, a system includes an input device 100 on a vessel, such as a marine ship. The input device 100, according to an example embodiment is installed at a region that is below deck, in a position such that it is able to receive input from a person who is located exterior to the ship, near the location at which the input device 100 is arranged. The location of the input device 100 can be approximately at the waterline, so that the area external to the ship, near the input device 100, can be reached by a person in the water.

In an example embodiment, the input device 100 is configured to receive input responsive to which a triggering device 104 is caused to trigger the deployment of safety equipment 106 so that the safety equipment is then accessible by the person in the water.

In an example embodiment of the present invention, the input device 100 is installed interiorly of the ship's hull, below deck, in a position such that it is able to receive input from the person who located exterior to the ship, near the location at which the input device 100 is arranged, e.g., such the hull separates between the input device 100 and the person. For example, the input device 100 can be a proximity sensor, e.g., a capacitance-based proximity sensor, that senses input by proximity of the person's body on the other side of the hull.

For example, the input device 100 is mounted inside the vessel, at a location and height above the waterline, e.g., of the vessel manager's choosing. Electronic control components, battery, and through-hull remote sensing switch can be arranged at that location. The penetration-less through-hull remote sensing switch can use capacitance to detect when a human places a body part, usually a finger or a hand in close proximity to the sensor. The sensor's location can be marked (conspicuously or inconspicuously) on the outside of the vessel to allow for easy identification of the area requiring the input, may be located on or near the vessel lettering, or it may remain unmarked to as to not reveal the presence of the system to those the vessel manager may not wish to be made aware of such emergency life-saving and ingress system, such as pirates or vandals.

In an example embodiment of the present invention, the proximity sensor input device 100 is coupled to a signal analyzer 102, e.g., including a processor that executes code stored on a computer-readable medium, which analyzes the input received by the input device 100 to determine whether the input satisfies a triggering condition. According to this embodiment, the switching mechanism operable by a person outside the ship is installed in the ship without penetration of the ship's hull.

In an example embodiment of the present invention, the input device 100 includes circuitry that, responsive to an object being in sufficient proximity thereto, outputs a predetermined voltage, e.g., 25.V-3.5V, to the signal analyzer 102. In an example embodiment, the signal analyzer 102 is configured to, responsive to determining that a triggering event has occurred, e.g., responsive to the satisfaction of programmed criteria, transmit a trigger signal to the triggering device 104 that causes the triggering device 104 to deploy the safety equipment 106.

In an example embodiment of the present invention, the combination of the input device 100, signal analyzer 102, and triggering device 104 includes circuitry for detecting the proximity of an object, a control microprocessor or other suitable circuitry for analysis of sensor signals, and electrical circuitry and/or mechanical components for responsively deploying safety equipment.

In an example embodiment, the signal analyzer 102 executes an algorithm to distinguish human-purposefully-generated signaling from random signals created by nature or other accidentally generated signals. In an example embodiment of the present invention, once the sensing switch is operated, the signal analyzer 102 uses timing information of the input signals to determine whether the input matches timing requirements for triggering the deployment of the safety equipment. In an example embodiment of the present invention, variables of the algorithm include one or more, e.g., all, of signal length, a time period in which a plurality of signals are input, and a pattern of a plurality of time periods. The timing pattern can be preprogrammed in a fixed manner. Alternatively, the system includes a user interface by which to set the timing pattern. In an example embodiment of the present invention, a timing pattern corresponding to the internationally recognized SOS pattern is used. For example, according to the latter embodiment, proximity signals are required which take the form of three short bursts, followed by three longer bursts, followed by three short bursts. A user can provide such a triggering input by banging or tapping on the ship's hull in the requisite timing pattern, which input does not require very precise and nimble input, thus being particularly suitable for use by a person who is in under duress, but still requires a pattern complexity unlikely to be replicated accidentally or by forces of nature. (According to example embodiments of the present invention, actual tapping or other contact is not required since a proximity signal can be generated by, for example, disruption of an electromagnetic field, for example, by placement of an object within the field, within a certain distance of the sensor and hull, so that a contactless tomahawk chop-like motion would work just as well. However, an overboard person most likely would provide the input with contact.)

For example, the signal analyzer 102 is configured to determine for each received proximity signal, the respective duration of the proximity signal, and determine whether duration of the proximity signal is within a predetermined required range, e.g., 0.2-2.5 seconds. For example, according to the embodiment in which the input device 100 provides a 2.5V-3.5V output to the signal analyzer 102 where proximity input is provided to the input device 100, the signal analyzer records the amount of time the voltage level is sustained without interruption. For example, the signal analyzer 102 can be configured to check for a voltage of 2.5V-3.5V on one pin, e.g., from a single direction, such as whether voltage has risen from less than 1V to above 2.5V, and, in an example embodiment, once the threshold voltage, e.g., of 2.5V-3.5V is reached, the signal analyzer 102 begins counting time until the voltage drops back down to less than 1V, which counted time is compared to the predetermined required range, e.g., of 0.2-2.5 seconds. The time can be recorded, for example, by referencing a system clock signal.

In an example embodiment, responsive to determining that the proximity signal is sustained for not less than and not more than the required time range, the system increments a variable that represents the number of times the input signal has been received. For example, if the signal lasts less than 0.2 second or more than 2.5 seconds, the signal is ignored. 0.2-2.5 second may be an appropriate required range since this is an expected range of time a person is expected cause an interruption in electric field by placing the user's hand in proximity to the input device 100 in a tomahawk chop-like motion at slow and fast paces. However, ranges of time may be selected.

In an example embodiment of the present invention, the signal analyzer 102 further records a time period in which the plurality of signals meeting the individual signal timing criteria are input, and determines whether a requisite number of such signals occurs within a predetermined time period and/or whether a maximum number of such signals occurs within the predetermined time period or within a second predetermined time period. For example, the system can be set to require at least 5 of such signals within 18 seconds and not more than 7 of such signals within 22 seconds (these numbers being selected for illustrative purposes). If too few signals occur or too many signals occur in the relevant time period(s), the system is configured to ignore the signals and clear the increment variable.

In an example embodiment, if the time period of the obtained signals meets the predetermined time period requirements, the system and method of the present invention is configured to responsively cause the safety equipment 106 to be deployed.

In an example embodiment of the present invention, the system can require signals to be input in each of a plurality of distinct time periods within an over all time period, for example, where there are different time requirements for the different time periods. For example, the system can require a first number of input signals to be received in a first time period whose length is within a first predetermined range, a second number of input signals to be received in a second time period whose length is within a second predetermined range, and a third number of input signals to be received in a third time period whose length is within a third predetermined range; and can further require that all three time periods occur in an overall time period whose length is within a fourth predetermined range.

In an alternative example embodiment of the present invention, the system does not require the signals recognized as meeting the duration requirements to be input in groups in periods whose lengths are independently subject to time period constraints, such as a minimum number of signals within a time period or a maximum number of signals with a time period, and/or does require such period constraints, but does not cause deployment of the safety equipment 106 to be deployed on that basis alone. According to this alternative example embodiment, the signal analyzer 102 tracks signals within multiple time periods and determines whether relative lengths of the time periods to each other meet predetermined criteria. An advantage of determining whether to trigger the deployment of safety equipment based on relative durations of the different period of time is that different people tap for providing trigger input at different paces, but generally the ratios of long taps to short taps do not vary much between different people.

For example, as noted above, in an example embodiment of the present invention, the system is configured to cause deployment of the safety equipment 106 responsive to input of the SOS signal, formed of three short signals, followed by three long signals, followed by three short signals again. A person is expected to input such signals by pounding or tapping on the vessel hull three times in quick succession, followed by three times in slower succession, followed again by three times in quick succession (though, as noted above, actual contact is not required according to example embodiments of the present invention). The variation between quickly input signals and the slowly input signals is expected to be formed of differences between pairs of pounding actions and/or differences in the length of time the person keeps the person's body against the vessel's hull for each pound against the hull. Therefore, in an example embodiment, for the SOS signal, the signal analyzer 102 increments the increment variable for each significant input signal, i.e., for each input signal that meets the signal duration requirement of, for example, 0.2-2.5 seconds, until the increment variable reaches three, in response to which the signal analyzer clears the increment variable and records the time period between the beginning of the input of the first three signals and the end of the input of the first three signals. The signal analyzer 102 then does the same for each of the next two sets of three input signals. The signal analyzer 102 then determines whether the recorded time periods meet a predetermined criterion for relative lengths. For example, the system analyzer 102 can be configured to require the length of the middle time period to be between 1.5-2.5 times as long as each of the first and third time periods. If the ratio of the middle time period to either of the first and third time periods does not fall within the prescribed range, the system is configured to ignore the input, but, if the ratio of the middle time period to each of the first and third time periods does fall within the prescribed range, the system is configured to trigger deployment of the safety equipment 106. The number of time periods taken into account, the number of signals required per time period, and the ratios between different ones of the time periods can differ from those described depending on the required signal, which can be fixed or which can alternatively be modified in a user interface.

FIG. 2 is a flowchart that illustrates the described method of ensuring that preprogrammed timing pattern criteria is satisfied, in response to the satisfaction of which, the system is configured to deploy safety equipment, according to an example embodiment of the present invention. At step 200, the system sets an increment variable ‘i’ to 0. At step 202, the system detects whether a signal is received. If a signal is detected to have been received, the system, at step 204, determines whether the signal satisfies a durational requirement, such as whether the signal is between 0.2-2.5 seconds in length. If it does not, then the signal is ignored. If it does satisfy the durational requirement, the system proceeds to step 206 at which the system increments ‘i’. (FIG. 2 does not illustrate a requirement of the incrementing of the signal count occurring in a required time period, although, as discussed above, the system can, in an example embodiment, be programmed with such a further requirement as well.)

After incrementing ‘i’, the system, at step 208, determines whether ‘i’ meets a defined threshold. Such a threshold can be the same for each of a plurality of time intervals or can vary between time intervals. For example, according to the embodiment in which the system is configured for determining whether the SOS signal has been received, the threshold is three for each of three time periods, since an SOS signal requires three sets of three inputs.

If the threshold is determined not to have been met, the system returns to waiting for the next signal. If the threshold is determined to have been met, the system responsively, at step 210, records the time period in which the signals that contributed to the increment of ‘i’ to the threshold number occurred.

At step 212, the system determines whether the required number of signal input periods have occurred. For example, although not shown in FIG. 2, the system can maintain another variable that the system similarly increments each time the system determines that ‘i’ meets its required threshold, and compare the other variable to another threshold. In an example embodiment of the present invention, the system is configured to further record a duration between the final signal of a first of a pair of time adjacent signal input periods and a first signal of a second following one of the pair of time adjacent signal input periods, and to reset the variable tracking the number of periods that have occurred if the recorded duration exceeds a predetermined threshold.

If the required number signal input periods has not yet occurred, the system returns to step 200 to reset ‘i’ to begin the next signal input period. If the required number of signal input periods has occurred, the system, at step 214, compares the recorded periods of times for the different signal input periods to each other. For example, the system can divide the length of time recorded for the signal input period that occurred second (in time) by the length of time recorded for the signal input period that occurred first (in time), and also divide the length of time recorded for the signal input period that occurred second (in time) by the length of time recorded for the signal input period that occurred third (in time).

At step 216, the system determines whether the relative lengths of time meet a required condition(s), e.g., whether programmed ratios of the lengths of time are met. If the required relationships are not met, the information recorded for the signal input periods is cleared at step 217 and the system returns to step 200. If the required relationships are met, the system, at step 218, triggers release and/or deployment of safety equipment.

Although not shown, in an example embodiment of the present invention, after step 218, the system proceeds to step 217. In an example embodiment, after step 218, proceeding of the system to step 217 requires a manual reset, e.g., after the safety equipment is returned to its installed state.

In an example embodiment of the present invention, as an extra precaution to avoid unintentional deployment of the safety equipment, the system is configured to require two input patterns that each meet the required timing criteria. In response to the first determined input satisfying the timing criteria, the system is configured to mark the occurrence of the event, and, in an example embodiment, output an alarm, e.g., an audible acoustic alarm, indicating the recognition of the occurrence of the event. For example, the alarm may be an output voice message stating “Event Detected, Please Now Repeat!” If another set of time pattern condition satisfying input is then received, e.g., beginning within a predetermined maximum time, e.g., 10 seconds, after the occurrence of the first even and/or such that the two events occur within a maximum predetermined time, e.g., 45 seconds, the system is configured to responsively cause the triggering device 104 to deploy the safety equipment. In an example embodiment, the system is also configured to output a warning signal, e.g., an at least 110 db acoustic signal for 20 seconds, indicating that the safety equipment is being deployed. In an example embodiment of the present invention, whether the system requires two trigger events or deploys after occurrence of just one trigger event is a user-selectable option, which can be set, e.g., by operation of a switch or soft key of a graphical user interface.

In an example embodiment of the invention, aside from time sequence pattern matching, the system further ensures that an input signal is not by a, for example, naturally occurring force, by use of redundant sensors. For example, in an example embodiment, the input device 100 includes multiple, redundant sensors arranged over an area larger than that which would be required for all of the sensors to sense the proximity of a single person. If the same or similar sensor signals are detected by more than one of the sensors, the system determines that the signal is to be ignored. The system can be configured in this way since, if the signal is detected by multiple ones of the redundantly arranged sensors, then it can be assumed that a naturally occurring event is being detected, rather than an intentionally provided user input. The redundancy of the sensors can thereby be used as a noise filter. In an example embodiment, not all redundantly detected inputs are ignored. For example, if an entire pattern is matched by detected input of only one of the sensors, and only a few of the input signals, e.g., fewer than a predetermined threshold number, are detected by others of the sensors, then the signals of the sensor that math the pattern are used for triggering deployment of safety equipment.

In an example embodiment of the present invention, the above-described sensor and trigger arrangement is provided as a kit that can be installed on any of a plurality of vessels. However, different vessels can be made of different materials, and the thickness of their hulls can vary. Therefore, according to an example embodiment of the present invention, to accommodate a plurality of types, materials, and thicknesses of vessel hulls, the proximity sensor can be calibrated for the vessel in which it is installed. For example, the proximity sensor can include a calibration arrangement by which, when the sensor is installed and first turned on, the proximity sensor produces an electric field, senses the resistance to the produced electric field, and records the sensed resistance as a baseline. An input signal is thereafter sensed to have occurred when a threshold difference from the baseline is sensed.

In an example embodiment of the present invention, the system is provided with a test mode, in which the system senses user input and determines whether conditions are satisfied as described above; but, responsive to determining that the required conditions are satisfied, does not deploy safety equipment, and instead outputs results, e.g., via a graphical user interface of a display device or via another, e.g., visual or acoustic, output device. For example, in an example embodiment, responsive to determining that the conditions are met, the system outputs an indication that the conditions for deployment have been met. In an example embodiment, the system includes a mechanical and/or electrical and/or software-based switch operable by a user to enter (and/or exit) the test mode. In an example embodiment, the test mode times out after a predetermined amount of time, lest a tester forget to return the system to the active mode, which can lead to danger if the system therefore does not deploy the safety equipment when needed because the system had been left in the test mode.

In an example embodiment of the present invention, the system for sensing and analyzing the input signals and triggering deployment of safety equipment remains in an “on” state as long as a power source to which it is coupled supplies power, without a switch for turning the system off, so that a person does not become stranded outside the vessel, without means of ingress due to the system being off. The system powers into the “on” state automatically upon receiving a sufficient supply voltage. Thus, in an example embodiment, as soon as the supply voltage is provided to the system, the system is placed in a state in which the system senses proximity of an object and runs an algorithm for determining whether a triggering event has occurred in order to deploy safety equipment when such an event is detected.

In an example embodiment of the present invention, the system draws power from a power source and remains in an “on” state even when the vessel in which it is installed is powered off. This is advantageous as often the vessel is powered off when a person is outside the vessel and seeks means of ingress.

According to example embodiments of the present invention, the sensor, detection, and safety equipment deployment system runs on 12V-28V power. In an example embodiment of the present invention, the system is connected to and continuously receives power from a 12-14V primary power line of the vessel in which it is installed, on which power the system runs, and is further connected to a redundant second source of 12-14V power should the primary line fail. In an example embodiment, the system further includes a separate internal rechargeable battery, e.g., a 12V rechargeable battery, from which to drawn power should the primary and redundant power lines fail, until the rechargeable battery reaches a low voltage cut off limit (at which point the system ceases to draw power from the battery in order to prevent over drain of the battery, which would damage the battery), at which time the system shuts down and awaits return of a power source. For example, the system can be provided with a rechargeable battery that can power the system for at least six hours. In an example embodiment, the battery is user-replaceable and of standard format and size.

In an alternative example embodiment, fewer power sources, e.g., a single, e.g., 12V-14V, power source, e.g., of the vessel in which the system is installed.

In an example embodiment of the present invention, the system includes a 6V and a separate 9V supply voltage (6V and 9V being power voltage value requirements of commonly available sensors) at 0.5 amp to run a signaling switch, e.g., a proximity sensor. When input satisfying the timing conditions for triggering deployment of the safety equipment is determined to have been received, the system is configured to activate a relay switch that releases a high amp, e.g., 15 amp, 12V or 28V power source, e.g., that runs for approximately 30 seconds, to power a device that deploys the safety equipment (12V and 28V being power voltage values of power sources commonly used for powering pyrotechnic devices). The high amp power can be in the form of a line out of the sensor and detection system to the deployment device, which line is separate from the two incoming power source connections to the sensor and detection system. For example, the sensor and detection system can receive power from the vessel and/or from an internal battery source, and can further include another power source for powering the safety equipment deployment device. In an example embodiment, a power source of the vessel in which the system is installed can also be used by the sensor and detection system to power the safety equipment deployment device. In an example embodiment, even according to this alternative, a back-up battery can also be provided for the system for powering the safety equipment deployment device in case of failure of the vessel power.

According to example embodiments of the present invention, a door is in a closed position and/or bolted shut, and, as discussed above, is released and/or actively opened to save a person outside a vessel in response to detection of a triggering event. Such a door can be released to provide a means of ingress. In an example embodiment, a fold-out ladder is attached to the door, which ladder folds out with the opening of the door to allow for easier access to the location of ingress at the gap created by the opened door. In an alternative example embodiment, the door is not framed by an ingress opening in the vessel, but rather is a door of a housing that houses other safety equipment that is released from the housing by the opening of the door. Such safety equipment can include, for example, a rope or other type of ladder and/or a floatation device.

The release of the door from its closed position can be, for example, by use of an explosive bolt, pyro-driven cable cutter, pyro-separator, a gas expansion separator, any suitably appropriate solenoid, any suitably appropriate servo, or an electro-mechanical release to release or sever a restraint that maintains the door in a closed position, or any suitably appropriate pin-puller mechanism by which a latch is electrically pulled back, thereby releasing the door.

In an example embodiment of the present invention, the restraint is released by a heating element that burns, melts, or otherwise cuts through the restraint. For example, in an example embodiment, the restraint is formed of a material such as nylon or polypropylene and is in the form of, for example, a hook-and-loop fastener arrangement such as that made by VELCRO®, which material is in contact with a heating element that bores through the material at the location of contact when the heating element is heated. Thus, when a triggering event is detected, the system triggers a source for heating the heating element, thereby severing the restraint. In the example embodiment, the material is threaded with a nichrome wire, an exposed portion of which being in contact with the material at at least one position of the restraint, the nichrome wire, thereby burning through the material at the contact position when the nichrome wire is heated.

In an example embodiment of the present invention, the restraint is non-mechanical. For example, in an example embodiment, the restraint is a device that produces an electro-magnetic field that magnetically restrains the safety equipment, and the system is configured to cause the device to cease producing the electro-magnetic field in response to detection of a triggering event.

In an example embodiment of the present invention, the ladder or other safety equipment held within the housing is arranged to extend outward to the person outside the vessel by gravitational force and/or the door that is released for exposing a point of entry into the vessel is arranged to open outward upon release by gravitational force.

In an example embodiment of the present invention, a component for forceful opening of the door and/or ejection of safety equipment is additionally or alternatively provided. For example, in an example embodiment, a spring is used. For example, the spring can be biased in the opening and/or ejection direction, so that, upon release of the restraint, the spring actively opens and/or ejects the door and/or safety equipment. In an alternative example embodiment, the door is opened and/or the safety equipment is ejected by a hydraulic or gas-pressurized pushing mechanism. In an alternative example embodiment, the door is opened and/or the safety equipment is ejected by inflation of a bag, e.g., where a gas discharge system causes the inflation.

In alternative example embodiments, the safety equipment is directly fastened to a structure of the vessel by a restraint, e.g., a strapping, which restraint is released by one or more of the above-described mechanisms. For example, in an example embodiment, a foldable ladder is folded against and fastened, by a strapping, to a stanchion or rail of the vessel, and upon release of the strapping and/or activation of an active ejection device, folds outward and down to a person outside the vessel. For example, the ladder extends from the deck of a marine ship down to and/or below the waterline upon release and/or ejection.

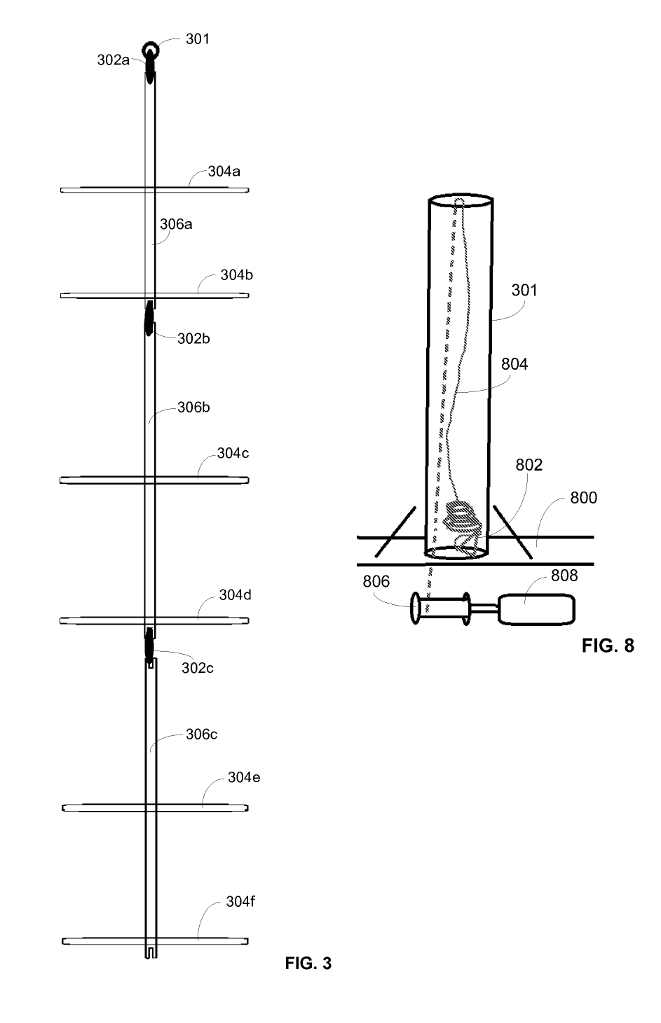

FIG. 3 illustrates an example foldable ladder 300 attached to a stanchion 301 of a vessel. For example, a plurality of stanchions can be arranged about the perimeter of the ship deck, or a portion thereof, to support life lines, and a foldable ladder, like that shown in FIG. 3, can be attached to each of one or more of the stanchions. The ladder 300 includes a plurality of ladder segments hingedly attached to each other by hinges 302b and 302c, allowing the segments to be folded into a stacked position or expanded into an extended position. Each of one or more of the segments includes one or more rungs 304(a-f) that extend transverse, e.g., perpendicularly, to a respective support beam 306(a-c) of the respective segment. The ladder further includes a hinge 302a by which the ladder 300 is fastened to the stanchion 301, e.g., at a bottom part of the stanchion, i.e., near the deck, for example, such that the longitudinal axes of the support beams 306a-306c, when in the completely folded position and when in the completely extended position are approximately parallel to the longitudinal axis of the stanchion 301 to which the ladder 300 is fastened and such that the longitudinal axes of the rungs 304a-304f extend transverse, e.g., perpendicularly, to the stanchion 301.

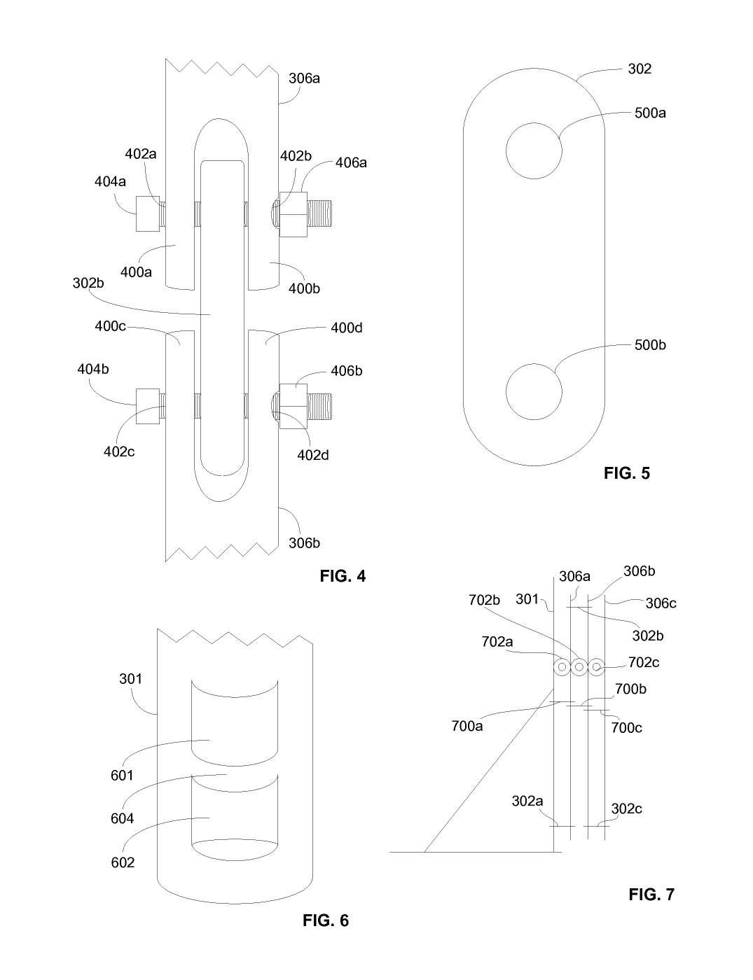

FIG. 4 shows an example part of the ladder 300, where two ladder segments are hingedly coupled to each other. As shown in FIG. 4, according to an example embodiment of the present invention, the support beams (such as illustrated support beams 306a and 306b) are of a double-sided tuning fork shape (only one side of each of the support beams 306a and 306b being shown in the figure), such that a hinge plate of hinge 302b can be inserted to extend from between the respective pair of prongs 400a-400b of one of the support beams 306a to between the respective pair of prongs 400c-400d of the other of the support beams 306b. Each of the prongs 400a-400d includes respective boreholes 402a-402d therethrough, for insertion therein of respective bolts or rivets 404a-404b. The inserted bolts or rivets 404a-404b also extend through respective boreholes 500a and 500b of the hinge plate, as shown in FIG. 5. Nuts 406a-406b can be threaded onto respective ones of the bolts or rivets 404a-404b to secure the bolts or rivets 404a-404b to prongs 400a-400d and hinge plate of the hinge 302b.

In an example embodiment, as shown in FIG. 6, the stanchion 301 includes two windows 601 and 602 separated by a bar 604 which fixedly extends through one of the boreholes 500a of hinge plate 302a, which is secured to support beam 306a with a bolt or rivet that extends through the other borehole 500b of the hinge plate of hinge 302a (as described above with respect to the hinged connection of different segments of the ladder 300). In an alternative example embodiment of the present invention, the stanchion 301 includes a large slot into which the entire width of the hinge plate of hinge 302a can be inserted, and further includes boreholes through which a bolt or rivet can be inserted for fastening of the hinge 302a to the stanchion 301 as described above with respect to the fastening of the hinges to the support beams of the ladder 300.

In an example embodiment of the present invention, each of one ore more of the support beams is a 1″ rounded polished stainless steel bar that is 24″ in length, with a first rung, for example, of the same material, welded to the support beam at approximately 1.75″ from a first end of the support beam, and a second rung, for example, of the same material, welded to the support beam at approximately midway of the length of the support beam. The rungs can be, for example, 17″ long bars, e.g., elliptically shaped, with approximately 1″ (or slightly larger than 1″) diameter boreholes drilled therethrough through which the support beam is inserted. Once the support beam is inserted into the rungs and correctly positioned, the rungs can be welded in place. (Alternatively, the boreholes or slits can be drilled in the support beam, and the rungs can be inserted therethrough.)

In an example embodiment of the present invention, the prongs at the ends of the support beams are formed by respective 1.5″ deep notches cut into the respective ends of the support beams, the notches being 9/16″ wide.

Although each of the ladder segments is shown in FIG. 3 to include only a single support beam 306a-306c, in an alternative example embodiment, each segment can include two or more support beams for a sturdier construction. For example, the segments can each include two support beams, with the rungs extending between the two support beams. With respect to the ladder segment directly coupled to the vessel, each of the support beams can be coupled to a respective one of a pair of, e.g., adjacent, stanchions. Alternatively, only one of the support beams is attached to a stanchion. In an example embodiment, at least the ladder segment directly coupled to the vessel includes a third support beam in the center between the other two of the segment's support beams, which center support beam is connected to a stanchion.

FIG. 7 illustrates the ladder 300 in a folded state while attached to the stanchion 301. According to an example embodiment of the present invention, as shown in FIG. 7, restraints 700a-700c maintain the ladder 300 in the folded position. Although three restraints 700a-700c are shown, fewer may be provided in alternative example embodiments. For example, restraint 700b can be omitted. As described above, the restraints can be released in response to a trigger event. In an example embodiment, also as shown in FIG. 7, ejection components 702a-702c are arranged for applying a force to actively extend the ladder into the unfolded, extended position. For example, the ejection components 702a-702c can be in the form of springs, as described above that bias the ladder into the extended position. Although three ejection components 702a-702c are shown, in alternative embodiments one or more, e.g., all, of the ejection components 702a-702c may be provided. For example, in particular, component 702b can be omitted.

While the ladder has been described as including support beams notched at its ends for insertion therein of respective parts of a respective hinge plate, in an alternative example embodiment, the hinge plate is notched, and the support beams, which need not include notches, are inserted into the notches of the hinge plate, essentially the reverse of that which has been described above. The hinge plate, according to this example embodiment, includes a pair of prongs at each of two ends, each prong including a borehole therethrough, such that, for each pair of prongs, a respective bolt or rivet is extended through the borehole of a first one of the pair of prongs, into a first end of a borehole that extends through a respective support beam, out a second end of the borehole, and then into and through the borehole of a second one of the pair of prongs. The stanchion can similarly include a single borehole that extends therethrough, with the boreholes of a pair of prongs of a hinge plate, between which the stanchion is positioned, being lined up with the borehole of the stanchion for extension through the boreholes of a bolt or rivet.

In an example embodiment, both types of described hinge plates are used. For example, the hinge plate described with respect to FIGS. 4 and 5 are used between support beams of adjacent ladder segments, and the described notched hinge plate is used for attachment of one of the ladder segments to the stanchion. In a variant of this example embodiment, the hinge plate for attachment of the ladder to the stanchion includes a first side with a single borehole as described with respect to FIGS. 4 and 5 for attachment to a notched end of a ladder segment, and a second side that is notched for insertion therein of the stanchion. Such embodiments, where a hinge plate includes a notch for positioning to sandwich the stanchion is advantageous because any generic stanchion can easily be modified to mate with the hinge plate by drilling a borehole therethrough.

The described ladder design advantageously provides for a flush mount of the ladder in a manner that blends in with other structural components of the vessel, and thereby requiring a small footprint.

As noted above, other safety equipment can be provided in or on the vessel, arranged for being triggered by the sensing and trigger detection system. For example, a housing or contained can be mounted on deck, and a non-exhaustive list of safety equipment that can be included in the housing or container includes: a water-contact triggered inflatable life buoy, water-contact triggered inflatable life ring, one or more water-contact triggered inflatable life vests, a water-contact triggered light, an emergency radio, an emergency beacon, and another type of ingress device or component, such as a rope ladder.

In an example embodiment of the present invention, an ingress arrangement is provided, the ingress arrangement including a flexible rope or webbing ladder with sturdy aluminum, brass, titanium, or other corrosion resistant metal steps, or wooded steps.

In an example embodiment of the present invention, the ingress arrangement includes a scramble net.

In an example embodiment of the present invention, the ingress arrangement includes a harness or sling, a winch including a cable (or cord or rope) attached to the harness or sling, and a controller to cause the winch to reel in the cable, thereby raising a person (donning or holding onto the harness or sling) out of the water, allowing for the person to reenter the vessel. In an example embodiment, the winch is mounted inside or on the vessel, and, when a trigger event is detected, the harness or sling, which is connected to the winch via the cable, is released so that it is extended into the water (or to the waterline). The winch can then be operated by a person onboard or by the person being rescued to reel the person in. For example, according to the latter example embodiment, by which the person being rescued operates the winch, in an example embodiment, a controller is also attached to the cable, e.g., directly or via the harness or sling, which controller sends a wired or wireless signal to activate an electro-mechanical controller for driving a motor of the winch to reel in the cable.

FIG. 8 shows an example winch system according to an example embodiment of the present invention, in which a winch arrangement includes a bobbin 806 and motor 808 for rotating the bobbin to reel in a cord 804, to which is attached, e.g., at an end of the cord 804, a sling 802. In an example embodiment, the bobbin 806 (and/or the motor 808) is arranged below the ship deck 800, with the cord 804 extending therefrom, through a hollow stanchion 301 (the portion of the cable 804 represented in FIG. 8 by the dashed line), and around over the top of the stanchion 301. The remainder of the length of the cord 804 and/or the sling 802 can in initially be contained within a housing, e.g., at the top of the stanchion 301. Responsive to detection of a trigger event, the system releases a door of the housing, thereby releasing the previously contained portion of the cord 804 and attached sling 802, so that they extend over the ship hull and to the water below.

In an alternative example embodiment, the cord 804 is initially partly wound around the bobbin 806, with only a small amount of the cord 804 and the sling 802 extending over the top of the stanchion 301, and, responsive to detection of the trigger event, the system triggers the motor 808 to spin the bobbin 806 in a first direction to extend the cord 804 and lower the sling 802 in the water, the motor being operable, e.g., by a controller attached to the sling 802, to reverse the spinning direction of the bobbin 806 to reel in the cord 804 once the person has grabbed hold of the sling 802.

The above description is intended to be illustrative, and not restrictive. For example, while the examples were described with respect to a marine vessel, described features of the invention can be applied to aerospace vessels and/or other locations to which access is to be granted by input of a code. For example, a proximity sensing arrangement and/or a signal analyzer that performs pattern matching based on the timing of received input, as described herein, can be used in a system by which a user gains access, for example, to a building, or vehicle by input of a code, with requirement of a key or arrangement that penetrates a building structure. Additionally, for example, instead of use of a passive proximity detection sensor, as described, in other example embodiments, an active input detection sensor can be used, for example, that produces an output to actively seek the presence of an object. For example, an active electromagnetic or energitic emitter coupled with a receiver can be used to detect whether a person's hand has been placed in proximity of the sensor. For example, ultrasound, radar, or x-ray sensors can be used.

Those skilled in the art can appreciate from the foregoing description that the present invention may be implemented in a variety of forms, and that the various embodiments may be implemented alone or in combination. Further, it is to be understood that the phraseology or terminology employed herein is for the purpose of description and not of limitation. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

What is claimed is:

1. A foldable ladder comprising:
a plurality of ladder segments, each of at least some of the ladder segments including:
a support beam that, at least one end of the beam, is notched to form a respective pair of prongs, a borehole extending through each prong;
at least one respective rung attached perpendicularly to the respective support beam of the respective ladder segment;
a first hinge plate through which extends:
a first borehole in alignment with the boreholes of the pair of prongs of a first one of a pair of the at least some of the ladder segments; and
a second borehole in alignment with the boreholes of the pair of prongs of a second one of the pair of the at least some of the ladder segments;
a first bolt or rivet that extends through the boreholes of the pair of prongs of the first one of the pair of the at least some of the ladder segments and through the first borehole of the first hinge plate; and
a second bolt or rivet that extends through the boreholes of the pair of prongs of the second one of the pair of the at least some of the ladder segments and through the second borehole of the first hinge plate.

2. The foldable ladder of claim 1, further comprising:
a second hinge plate through which extends:
a borehole at a first side of the second hinge plate in alignment with boreholes of a second pair of prongs of the first one of the pair of the at least some of the ladder segments; and
at least one borehole at a second side of the second hinge plate in alignment with at least one borehole through a stanchion fixed to a ship deck;
a third bolt or rivet that extends through the boreholes of the second pair of prongs of the first one of the pair of the at least some of the ladder segments and through the borehole at the second side of the second hinge plate; and
a fourth bolt or rivet that extends through the at least one borehole at the second side of the second hinge plate and the at least one borehole through the stanchion.

3. The foldable ladder of claim 2, further comprising:
a restraint that holds the foldable ladder in a folded state, in which the ladder is folded against the stanchion, the restraint being coupled to a trigger device that triggers release of the restraint in response to an input determined to match a predetermined timing pattern.

4. A vessel comprising:
a deck;
a hull;
a bobbin arranged below deck and interiorly of the hull;
a hollow stanchion, a first end of the hollow stanchion being fixed to the deck;
a cord, a first end of the cord being attached to the bobbin, the cord extending from the bobbin, through the hollow stanchion, and out a second end of the hollow stanchion that is opposite the first end of the hollow stanchion; and
a safety device attached to the cord exteriorly of the hollow stanchion.

5. The vessel of claim 4, further comprising:
a motor under the influence of which the bobbin is rotatable to wind at least a portion of the cord around the bobbin.

6. The vessel of claim 4, further comprising:
a restraint that maintains the safety device in a first position at the stanchion;
an input device; and
processing circuitry communicatively coupled to the input device, wherein the processing circuitry is configured to:
determine whether input signals received via the input device satisfy a predetermined timing constraint; and
responsive to determining, in the determination, that the predetermined timing constraint has been satisfied, output a trigger signal that causes release of the restraint, the safety device thereby being extended from the first position to a second position below deck and exteriorly of the hull.
